(19) United States
(12) Patent Application Publication
(10) Pub. No.: US 2026/0081495 A1
(43) Pub. Date: Mar. 19, 2026

(54) STATOR AND KIT OF PARTS

(71) Applicant: Schaeffler Technologies AG & Co. KG, Herzogenaurach (DE)

(72) Inventor: Stephan Penner, Bühl (DE)

(73) Assignee: Schaeffler Technologies AG & Co. KG, Herzogenaurach (DE)

(21) Appl. No.: 19/106,448

(22) PCT Filed: Aug. 3, 2023
(86) PCT No.: PCT/DE2023/100573

§ 371 Date: Feb. 25, 2025

(30) Foreign Application Priority Data
Aug. 29, 2022 (DE) 10 2022 121 743.4

(51) Int. Cl. H02K 3/14; H02K 3/24; H02K 9/19

(52) U.S. Cl. CPC H02K 3/14; H02K 3/24; H02K 9/19

(57) ABSTRACT

The invention relates to a stator (1) for an electric machine (2), in particular within a drive train (3) of a motor vehicle (4), wherein: the stator (I) is of cylindrical ring-shaped configuration and has a number of stator teeth (5) which, in the circumferential direction, between adjacent stator teeth (5), each define a stator slot (6) having two slot sidewalls (15) and a slot base (16), the stator slot extending in the radial direction and running in the axial direction through the stator (1), and into which slot an energizable winding (7) comprising
a number of conductors (8) is inserted; the conductors (8) have two conductor portions (9a, 9b) which run in parallel in an axial extent, are arranged in the stator slots (6) and have a contour that deviates from the circular shape in cross section, and exit from the stator (1) on an end side (14) of the stator (I) with in each case two free conductor ends (10) and form a winding head (11); and at least one of two radially adjacent conductor portions (9a, 9b) in a stator slot (6) is twisted along its longitudinal extent.

### CROSS-REFERENCE TO RELATED APPLICATIONS

This application is a U.S. national stage application under 35 U.S. C. § 371 that claims the benefit of priority under 35 U.S. C. § 365 of International Patent Application No. PCT/DE2023/100573, filed on Aug. 3, 2023, designating the United States of America, which in turn claims the benefit of priority under 35 U.S. C. § § 119, 365 of German Patent Application No. 10 2022 121 743.4 filed on Aug. 29, 2022, the contents of which are relied upon and incorporated herein by reference in their entirety.

### FIELD OF THE DISCLOSURE

The present disclosure relates to a stator for an electric machine, in particular within a drive train of a motor vehicle, the stator being designed in the shape of a cylindrical ring and having a plurality of stator teeth, which in the circumferential direction between adjacent stator teeth each define a stator slot which extends in the radial direction, runs in the axial direction through the stator and which has two slot sidewalls and a slot base, into which an energizable winding comprising a plurality of conductors is inserted, the conductors comprising two conductor portions which run parallel in the axial extent, are arranged in the stator slots and which have a contour deviating from circular shape in cross section, and which emerge from the stator at an end side of the stator with two free conductor ends each so as to form a winding head, wherein a cooling fluid can flow through the stator slots. The disclosure further relates to a kit of parts.

### BACKGROUND OF THE DISCLOSURE

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

### SUMMARY OF THE DISLCOSURE

A detailed description of an electric drive can be found in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged so as to be concentric and coaxial with respect to a bevel gear differential, wherein a shiftable 2-speed planetary gear set is arranged in the drive train between the electric motor and the bevel gear differential and is likewise positioned to be coaxial with the electric motor and the bevel gear differential or spur gear differential. The drive unit is very compact and allows for a good compromise between gradability, acceleration and energy consumption due to the shiftable 2-speed planetary gear set. Such drive units are also referred to as e-axles or electrically operable drive trains.

In addition to purely electrically operated drive trains, hybrid drive trains are also known. Such drivetrains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, drive can also be provided by the internal combustion engine and the electric motor at the same time in certain operating situations.

In the development of electric machines intended for e-axles or hybrid modules, there is a continuing need to increase their power densities, so the cooling of electric machines required for this is growing in importance. Owing to the necessary cooling capacities, hydraulic fluids such as cooling oils have become established in most concepts for the removal of heat from the thermally loaded regions of an electric machine.

Jacket cooling as well as winding head cooling are known, for example, from the prior art for cooling electric machines by means of hydraulic fluids. While jacket cooling transfers the heat generated at the outer surface of the stator laminated core into a cooling circuit, the heat transfer takes place in the case of the winding head cooling immediately at the conductors outside the stator laminated core in the region of the winding heads into the fluid.

Further improvements are provided by separate cooling channels, which are introduced both in the stator laminated core (see, for example, EP3157138 A1) and in the slot, in addition to the conductors (see, for example, Markus Schiefer: Indirekte Wicklungskühlung von hochausgenutzten permanenterregten Synchronmaschinen mit Zahnspulenwicklung [Indirect Winding Cooling of Highly Utilized Permanently Excited Synchronous Machines with Toothed Coil Winding], dissertation, Karlsruhe Institute of Technology (KIT), 2017).

Concepts are also known in which hydraulic fluid flows directly around the windings in order to increase the power density. Improved cooling with direct contact of the hydraulic fluid and conductor in the slot is already known per se from the prior art. For example, DE102015013018 A1 describes a solution for electric machines with a single-tooth winding, wherein the fluid flows directly around the windings, which are wound around the teeth.

Electric machines that have a hollow-cylindrical stator, i.e. are designed as internal rotor machines, and that are configured for use as a traction drive of a motor vehicle often have a stator winding with a rectangular cross section in order to achieve a high power density. In electric machines intended for driving motor vehicles, the stator windings are therefore typically designed as hairpin windings. In this case, for example, substantially U-shaped wire segments are introduced into the stator slots from one end side of the stator and then shaped at an opposite end side of the stator and connected, for example, by welding.

It is the object of the disclosure to provide a stator with a winding for an electric machine which allows improved cooling performance and higher performance or has improved efficiencies. It is also the object of the disclosure to realize a kit of parts for forming a winding of a stator.

This object is achieved by a stator for an electric machine, in particular within a drive train of a motor vehicle, the stator being designed in the shape of a cylindrical ring and having a plurality of stator teeth, which in the circumferential direction between adjacent stator teeth each define a stator slot which extends in the radial direction, runs in the axial direction through the stator and which has two slot sidewalls and a slot base, into which an energizable winding comprising a plurality of conductors is inserted, the conductors comprising two conductor portions which run parallel in the axial extent, are arranged in the stator slots and which have a contour deviating from circular shape in cross section, and which emerge from the stator at an end side of the stator with two free conductor ends each so as to form a winding head, and a cooling fluid can flow through the stator slots, and in a stator slot at least one of two conductor portions adjacent in the radial direction is twisted along its longitudinal extent.

This has the advantage that the conductor portions can be centered and/or fixed in the stator slots, thus simultaneously enabling a uniform flow around the conductor portions. In particular, a particularly favorable ratio of flow cross section to electrical line cross section can be realized in the stator slot. The flow around the twisted conductor portions has also proven to be particularly uniform. Furthermore, the production of the twisted conductor portions is particularly simple and inexpensive in terms of manufacturing technology. The assembly process for the winding also does not need to be changed.

A significant advantage of the disclosure is therefore that the cross sections of the conductor portions do not need to be changed, but only twisted. There is also no need to adapt the stator slot geometry, which has a positive effect on the production of the stator and it would therefore also be possible in principle to equip an existing stator with the twisted conductors.

By using a conventional, for example rectangular wire cross section and a substantially U-shaped slot geometry with the usually required joining clearances, cross flows in the stator slot can be kept to a minimum by alternating constrictions. Furthermore, it has been shown that “dead water areas” (comparable to standing water, e.g. behind bridge piers in flowing waters) can be avoided. It has also been shown that the twisted conductor portions can prevent the accumulation of fine abrasion in the stator slots.

The stator according to the disclosure is preferably designed for use in a radial flux machine. A stator for a radial flux machine usually has a cylindrical structure and generally consists of electrical steel sheets that are electrically insulated from one another and are structured in layers and packed to form laminated cores. Distributed around the circumference, stator slots are embedded in the electrical steel sheet and arranged to run substantially parallel to the rotor shaft, said stator slots receiving the stator winding or parts of the stator winding. The stator slots preferably have a substantially U-shaped cross-sectional contour. Most preferably, the stator slots have straight slot walls extending in the radial direction.

A winding with conductors can particularly preferably be embedded in the stator slots of the stator according to the disclosure. A conductor is in particular an electrically conductive conductor with two conductor portions which run in parallel and comprise longitudinal extensions that are significantly larger than their diameters. In principle, the conductor portions can have any cross-sectional shape other than a circular shape. Rectangular cross-sectional shapes are preferred since these allow high packing densities and consequently high power densities to be achieved. Particularly preferably, a conductor is formed of copper. Preferably, a conductor is insulated. To insulate the conductors, for example, mica paper, which for mechanical reasons can be reinforced by a glass fabric carrier, may be wound in tape form around one or more stator windings, which are impregnated by means of a curing resin. In principle, it is also possible to use a curable lacquer layer without mica paper to insulate a conductor.

Most preferably, the winding is designed as a hairpin winding or wave winding. In this context, it is further preferred that the conductors are designed as hairpin conductors.

The stator according to the disclosure also has a stator body. The stator body can be made in one piece or in multiple pieces, in particular in a segmented manner. A one-piece stator body is characterized by the fact that the entire stator body is formed in one piece as viewed over the circumference. The stator body is usually formed from a plurality of stacked laminated electrical steel sheets, with each of the electrical steel sheets being closed to form a circular ring. A segmented stator body is characterized by the fact that it is constructed from individual stator segment parts. The stator body can be constructed from individual stator teeth or stator tooth groups, and each individual stator tooth or each individual stator tooth group can be formed from a plurality of stacked laminated electrical steel sheets, with each of the electrical sheets being designed as a stator segment lamination part.

The stator body is preferably formed from one or more stator laminated cores. A stator laminated core is understood to mean a plurality of laminated individual sheets or stator sheets, which are generally made from electrical steel sheets and are layered and packed one on top of the other to form a stack or what is referred to as a stator laminated core. The individual sheets can then remain held together in the laminated core by adhesive bonding, welding or screwing.

The stator teeth of the stator are preferably formed in the stator body. Stator teeth are components of the stator body which are designed as circumferentially spaced, tooth-like parts of the stator body that are directed radially inward, with an air gap for the magnetic field being formed between the free ends of the stator teeth and a rotor body. The gap between the rotor and the stator is referred to as the air gap. In a radial flux machine, this is a substantially annular gap with a radial width that corresponds to the distance between the rotor body and the stator body.

In particular, the stator can be provided for use in an electric machine within a drive train of a motor vehicle. The electric machine is intended in particular for use within a drive train of a hybrid or fully electrically driven motor vehicle. In particular, the electric machine is dimensioned such that vehicle speeds of more than 50 km/h, preferably more than 80 km/h, and in particular more than 100 km/h can be achieved. The electric machine particularly preferably has an output of more than 30 kW, preferably more than 50 kW and in particular more than 70 kW. Furthermore, it is preferred that the electric machine provides speeds greater than 5,000 rpm, particularly preferably greater than 10,000 rpm, very particularly preferably greater than 12,500 rpm.

According to an advantageous embodiment of the disclosure, the plurality, preferably all, of the electrical conductors have a substantially rectangular contour in cross section. The advantage of this design is that electrical conductors that are generally available as standard can be used to form the stator winding, which is particularly favorable in terms of the manufacturing costs of the stator.

The function of the cooling fluid in the stator according to the disclosure is to dissipate heat as efficiently as possible from regions of the stator that are heating up and to prevent these regions from overheating. In addition to this main task, the cooling fluid can in particular also provide lubrication and corrosion protection for the moving parts and/or the metal surfaces of the cooling system of the stator or the electric machine. In addition, it can, in particular, also remove contaminants (for example as caused by abrasion), water and air. The cooling fluid is preferably a liquid. The cooling fluid can in particular be an oil. In principle, however, it is also conceivable to use aqueous cooling fluids, for example also emulsions, such as water-glycol mixtures.

The cooling fluid of the stator can be connected to a hydraulic cooling system with a hydraulic cooling circuit. Such a hydraulic cooling system is used to dissipate the heat generated by electrical losses within an electric machine. Such a cooling system can have cooling channels within the rotor (rotor cooling channel) and/or stator (stator cooling channel), in particular also a flow through the stator slots, through which a corresponding cooling fluid is guided for the purpose of removing the heat.

The cooling fluid can particularly preferably be pumped through the hydraulic circuit by means of a pump. In principle, it is conceivable to design a plurality of hydraulic circuits in order to cool the electric machine. In this case, it is highly preferred that the cooling channels of the stator are connected to a hydraulic cooling circuit or to various cooling circuits of the cooling system. In particular, by connecting to several cooling circuits, it is possible to provide more precise cooling, since, for example, the temperature of the cooling fluid when entering the cooling channels of the stator, the flow velocity of the cooling fluid or even the type of cooling fluid (oil, emulsion) can be adjusted.

The stator slots are preferably closed by a slot closure means so that the cooling fluid cannot flow from the stator slots into the air gap between the rotor and the stator. Particularly preferably, the slot closure means is a slot closure wedge.

It may be advantageous for the conductor portions adjacent in the radial direction to be twisted along their longitudinal extent. It is basically conceivable that each conductor portion is twisted in a stator slot. Furthermore, it is also possible to twist only every second conductor portion in the radial direction.

According to an advantageous embodiment of the disclosure, it is possible for the conductor portions adjacent in the radial direction to be twisted in the same or opposite directions along their longitudinal extent, whereby the fluidic cross section within the stator slots can be further influenced. In the case of a torsion in the same direction, it is further preferred that the adjacent conductor portions are twisted with different torsion angles.

According to a further preferred development of the disclosure, it is also possible for the conductor portions accommodated in a stator slot to form a spring elasticity acting in the radial direction. This makes it possible to compensate for tolerances in the radial direction and also to fix the conductor portions in the radial direction within the stator slot.

Furthermore, according to a likewise advantageous embodiment of the disclosure, it is also possible for the conductor portions accommodated in a stator slot and adjacent in the radial direction to have a corrugation extending axially in phase in the circumferential direction. The advantageous effect of this embodiment is based on the fact that the winding can also be fixed in the slots in the circumferential direction by spring force.

According to a further particularly preferred embodiment of the disclosure, it is possible for conductor portions accommodated in a stator slot and adjacent in the radial direction to have a corrugation which is axially phase-shifted, in particular extends in an antiphase manner, in the circumferential direction.

This makes it possible in particular to achieve the effect that, when a spring force is provided that also acts in the circumferential direction, an improved cooling performance, because it is more uniform, can be achieved in the axial extension of the slot.

In principle, the elasticity of the corrugation can compensate for tolerances and thermal expansion of the conductor portions relative to the stator slots.

Owing to the torsion of the conductor portions and their corrugation, a type of elongated wave springs can be provided, the properties of which can be varied according to a given application. For example, the torsion and corrugation can be configured such that the conductor portions support each other on the opposite slot walls of a stator slot. The conductor portions can also be designed in such a way that the conductor portions support each other in the radial direction. Furthermore, it is also possible for the conductor portions to be subject to play, free of play or specifically prestressed in both spatial directions.

It is also preferred that the conductor portions accommodated in a stator slot and adjacent in the radial direction contact each other in the radial direction. Furthermore, a suitable choice of torsion and corrugation of the conductor portions makes it possible to form only point contacts and/or line contacts between the conductor portions of the conductors and with respect to the slot walls. In the case of line contacts, these are in the direction of flow so that no fluid flows only in the line contact, but no “dead water areas” are created, so that no or only very limited fine abrasion can accumulate in the direction of flow in front of or behind. Furthermore, the flow cross section per hairpin side then fluctuates only slightly, which leads to only low cross-flows and thus promotes uniform flow velocities, uniform heat dissipation and low flow resistance.

Furthermore, the disclosure can also be further developed in such a way that the winding has a first group of conductors, the first group of conductors having two conductor portions which run in parallel and are positioned in different stator slots of the stator, and at least one of the conductor portions being twisted along its longitudinal extent.

The advantage of this embodiment is that a stator slot through which cooling fluid can flow can be formed by using only one group of conductors in that the conductors, in particular the hairpin conductors, are inserted into the stator slots in a manner rotated, for example, alternately by 180° about their longitudinal axis.

In a likewise preferred embodiment of the disclosure, it is also possible for the first group of conductors to have two conductor portions which run in parallel and are positioned in different stator slots of the stator, the two conductor portions being twisted, for example, in opposite directions along their longitudinal extent. This can, for example, prevent assembly errors during insertion of the conductors into the stator slots.

It may also be advantageous to further develop the disclosure in such a way that the winding of the stator is formed from the first group of conductors, which promotes cost-effective production due to the high degree of uniformity.

In principle, however, it would also be possible to provide a second group of conductors which has a twisting of the conductor portions that differs from the first group of conductors, which can create additional degrees of freedom in the design of the flow-through cross-section in a stator slot.

Finally, the object of the disclosure can also be achieved by a kit of parts for forming a winding of a stator comprising a first group of conductors, the first group of conductors having two conductor portions which run in parallel and can be positioned in different stator slots of the stator, and at least one of the conductor portions being twisted along its longitudinal extent. The kit of parts can, for example, be a packaging unit.

The disclosure is explained in more detail below with reference to figures without limiting the general concept of the disclosure.

### BRIEF DESCRIPTION OF THE DRAWINGS

In the drawings:
FIG. 1 shows an electric radial flux machine in a sectional view;
FIG. 2 shows an electric radial flux machine in an axial sectional view;
FIG. 3 shows an axial sectional view through a stator slot with twisted conductor portions of the conductors;
FIG. 4 a cross-sectional view of a first embodiment of conductor portions in a stator slot at different axial positions;
FIG. 5 shows a cross-sectional view of a second embodiment of conductor portions in a stator slot at different axial positions;
FIG. 6 shows a plan view of a stator slot with conductor portions in different corrugations;
FIG. 7 shows a kit of parts for forming a winding of a stator in a schematic view;
FIG. 8 shows a motor vehicle with an electric drive train in a schematic block diagram.

### DETAILED DESCRIPTION

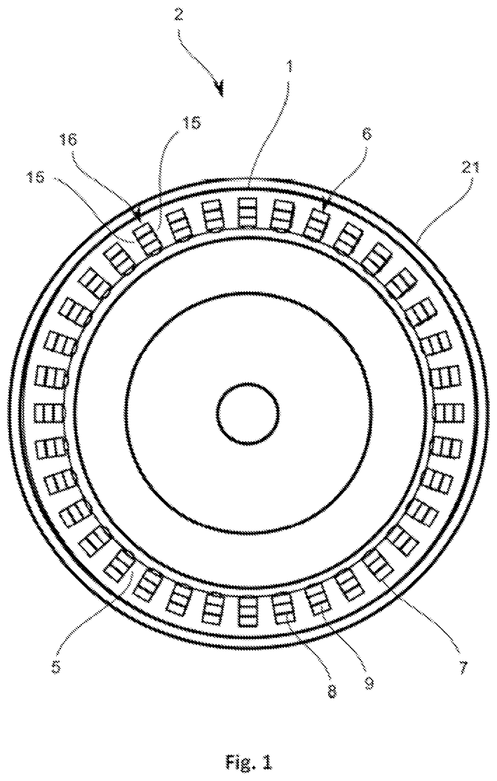

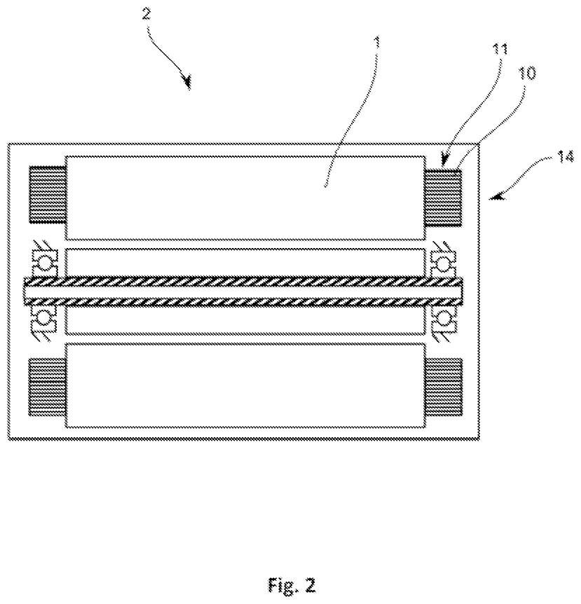

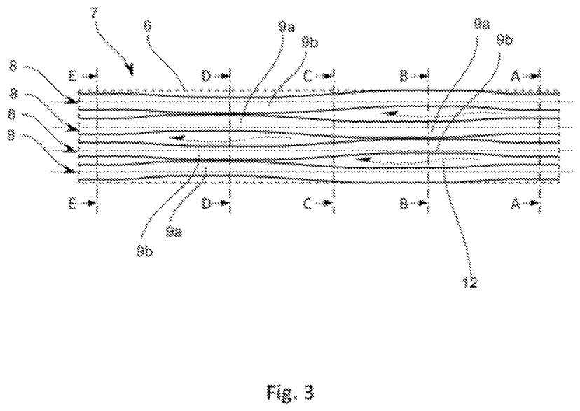

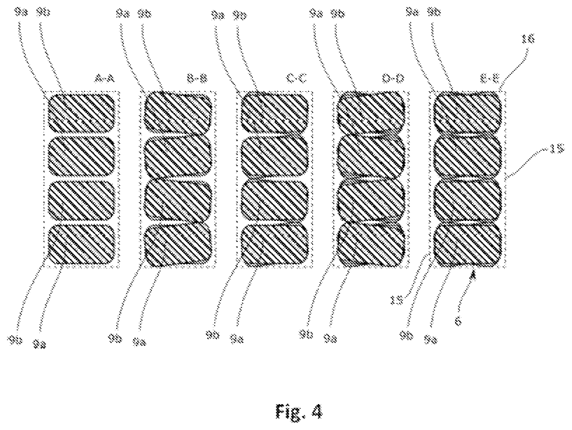

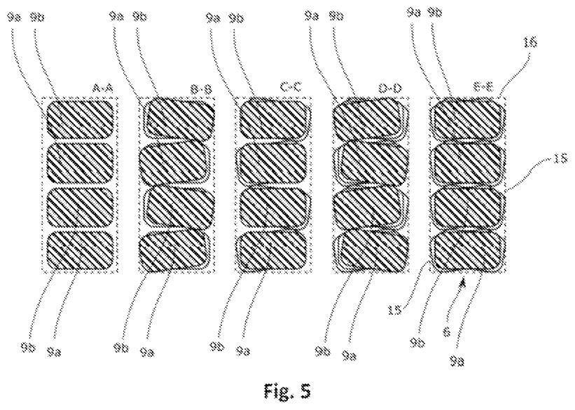

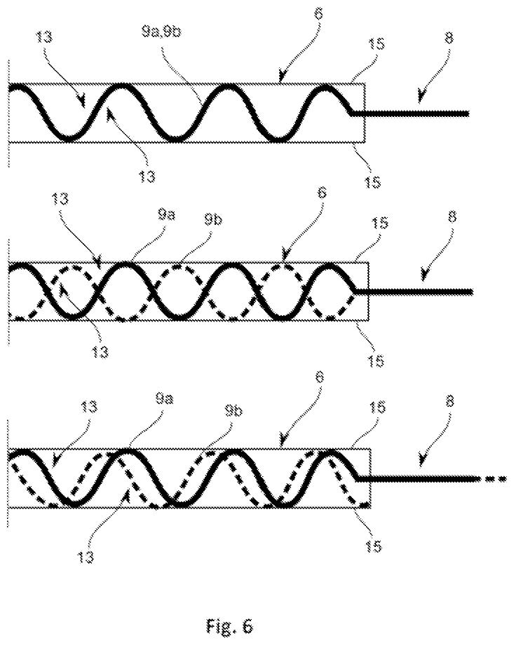

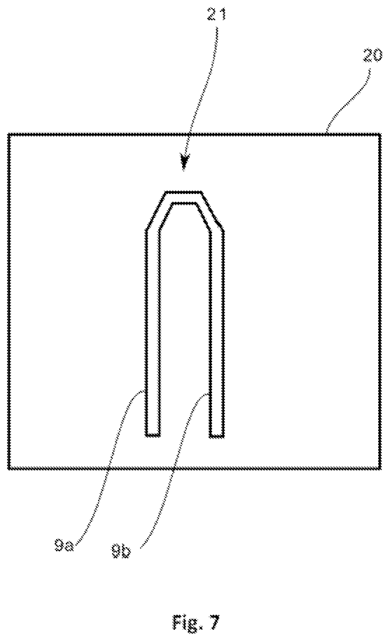

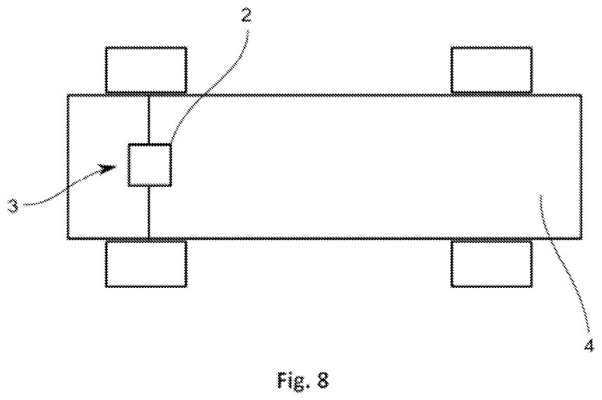

FIG. 1 and FIG. 2 show a stator 1 for an electric machine 2, in particular within a drive train 3 of a motor vehicle 4, as also drawn in FIG. 8. The stator 1 is in the shape of a cylindrical ring and has a plurality of stator teeth 5, which in the circumferential direction between adjacent stator teeth 5 each define a stator slot 6 that extends in the radial direction, runs in the axial direction through the stator 1 and has two slot sidewalls 15 and a slot base 16, into which an energizable winding 7 comprising a plurality of conductors 8 is inserted. In the embodiment shown, the winding 7 is designed as a hairpin winding and the conductors 8 are designed as hairpin conductors.

The conductors 8 have two conductor portions 9a, 9b which run parallel in axial extent and are arranged in the stator slots 6 and which have a contour deviating from circular shape in cross section. In the embodiments shown, the conductor portions 9a, 9b have a rectangular cross-sectional contour. The conductor portions 9a, 9b emerge from the stator 1 at an end side 14 of the stator 1 with two free conductor ends 10 each so as to form a winding head 11. The conductor portions 9a, 9b have a substantially rectangular cross-sectional contour.

A cooling fluid 12 can flow through the stator slots 6 of the stator 1, which will be explained in more detail below with reference to FIGS. 3-5.

As can be seen from a comparison of FIGS. 3-5, in a stator slot 6 at least one of two conductor portions 9a, 9b adjacent in the radial direction is twisted along its longitudinal extent.

It can also be seen from the figure that the conductor portions 9a, 9b adjacent in the radial direction are twisted in the same or opposite directions along their longitudinal extent.

It is also clearly evident from FIGS. 4-5 that the conductor portions 9a, 9b accommodated in a stator slot 6 form a spring elasticity acting in the radial direction.

As shown in FIG. 5, in this embodiment shown, the conductor portions 9a, 9b accommodated in a stator slot 6 and adjacent in the radial direction have a corrugation 13 which is axially phase-shifted, or more precisely extending in an antiphase manner, in the circumferential direction, which can also be clearly seen from the alternating radial contact of the conductor portions 9a, 9b on the slot sidewalls 15. In contrast, the embodiment of FIG. 4 has no corrugation 13.

The hairpin winding 7 has a first group of hairpin conductors 21, which has two conductor portions 9a, 9b that run in parallel and are positioned in different stator slots 6 of the stator 1, with at least one of the conductor portions 9a, 9b being twisted along its longitudinal extent. It is also fundamentally conceivable that the first group of conductors 21 has two conductor portions 9a, 9b which run in parallel and are positioned in different stator slots 6 of the stator 1, the two conductor portions 9a, 9b being twisted along their longitudinal extent. In the embodiments shown, the hairpin winding 7 of the stator 1 is formed exclusively from a first group of hairpin conductors 21.

FIG. 6 in particular clearly shows the various possibilities for providing the conductor portions 9a, 9b with a corrugation 13. In the top image of FIG. 6, the conductor portions 9a, 9b arranged radially one above the other in a stator slot 6 are provided with an in-phase corrugation 13. In other words, the conductor portions 9a, 9b are congruent when the stator slot 6 is viewed from above. The middle picture shows an embodiment in which the conductor portions 9a, 9b have an antiphase corrugation 13. In the embodiment shown, the corrugations 13 are substantially sinusoidal, such that in an antiphase configuration one conductor portion 9a follows a sine curve and another conductor portion 9b follows a cosine curve. The lower image in FIG. 6 shows two conductor portions 9a, 9b which have a phase offset from each other. Even if in the exemplary embodiments the conductor portions 9a, 9b have a sinusoidal corrugation 13, it is of course conceivable that the corrugation 13 can also have a different wave-like shape, such as a zigzag or sawtooth-like profile.

It is understood that the corrugation 13 and the torsion of the conductor portions 9 can be combined with one another as desired in order to form a defined flow of cooling fluid 12 through a stator slot 6.

FIG. 7 shows a kit of parts 20 for forming a hairpin winding 7 of a stator 1 comprising a first group of hairpin conductors 21, in which the first group of hairpin conductors 21 has two conductor portions 9a, 9b which run in parallel and can be positioned in different stator slots 6 of the stator 1, and at least one of the conductor portions 9a, 9b is twisted along its longitudinal extent.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SIGNS

1 Stator
2 Electric machine
3 Drive train
4 Motor vehicle
5 Stator teeth
6 Stator slot
7 Winding
8 Conductor
9 Conductor portions
10 Conductor ends
11 Winding head
12 Cooling fluid
13 Corrugation
14 End side
15 Slot sidewalls
16 Slot base
20 Kit of parts
21 First group of conductors

1. A stator for an electric machine, comprising:
a plurality of stator teeth that define a plurality of stator slots that are circumferentially offset from each other by stator teeth and that run in the axial direction through the stator; and
an energizable winding comprising a plurality of conductors that includes a first conductor and a second conductor, wherein the first conductor includes a first conductor portion that extends axially within a first stator slot of the plurality of stator slots and a second conductor portion that extends axially within a stator slot of the plurality of stator slots other than the first stator slot,
wherein the second conductor includes a first conductor portion that extends axially within the first stator slot and a second conductor portion that extends axially within a stator slot of the plurality of stator slots other than the first stator slot,
wherein each of the first and second conductor portions of the first and second conductors has contour deviating from circular shape in cross section taken at a given axial position along a plane normal to the axial direction, and
wherein in the first stator slot the first conductor portion of the first conductor is radially adjacent to the first conductor portion of the second conductor, and at least one of the first conductor portion of the first conductor and the first conductor portion of the second conductor is twisted along its longitudinal extent.

2. The stator of claim 1, wherein the first conductor portions of the first and second conductors are both twisted in the same direction along their longitudinal extents.

3. The stator of claim 1, wherein the first conductor portions of the first and second conductors form a spring elasticity acting in the radial direction.

4. The stator of claim 1, wherein the first conductor portions of the first and second conductors have corrugation extending axially in phase in the circumferential direction.

5. The stator of claim 1, wherein the first conductor portions of the first and second conductors have a corrugation that extends in an axially phase-shifted manner in the circumferential direction.

6. The stator of claim 1, wherein the winding has a first group of conductors, each conductor of the first group of conductors having two conductor portions that run in parallel and are positioned in different stator slots, wherein at least one of the conductor portions is twisted along its longitudinal extent. slots

7. The stator of claim 6, wherein the two conductor portions of each conductor of the first group of conductors are twisted along their longitudinal extents.

8. The stator of claim 6, wherein the winding is formed of the first group of conductors.

9. The stator of claim 1, wherein the first and second conductor portions of the first and second conductors have a substantially rectangular cross-sectional contour at the given axial position.

10. A conductor for forming a winding, comprising:
a first free conductor end;
a first conductor portion that extends from the first free conductor head;
a second free conductor end that is in a spaced-relationship with the first free conductor end; and
a second conductor portion that extends from the second free conductor head, wherein at least one of the first conductor portion and the second conductor portion is twisted along its longitudinal extent.

11. A stator for an electric machine, comprising:
a plurality of stator teeth that define a plurality of stator slots that are circumferentially offset from each other; and
a first conductor having a first conductor portion that extends axially within a first stator slot of the plurality of stator slots and a second conductor portion extends axially within a second stator slot, wherein the first conductor portion is twisted along a longitudinal extent of the first conductor portion.

12. The stator of claim 11, wherein the second conductor is twisted along a longitudinal extent of the second conductor portion.

13. The stator of claim 11, further comprising:
a second conductor having a first conductor portion that extends axially within the first stator slot and is disposed radially adjacent to the first conductor portion of the first conductor.

14. The stator of claim 13, wherein the first conductor portion of the second conductor is twisted along a longitudinal extent of the first conductor portion of the second conductor.

15. The stator of claim 14, wherein first conductor portions of the first and second conductors are both twisted in the same direction along their longitudinal extents.

16. The stator of claim 14, wherein first conductor portions of the first and second conductors are twisted in opposite directions along their longitudinal extents.

17. The stator of claim 1, wherein the first conductor portions of the first and second conductors are twisted in opposite directions along their longitudinal extents.
